(19) United States
(12) Patent Application Publication
(10) Pub. No.: US 2002/0190480 A1
(43) Pub. Date: Dec. 19, 2002

(54) Air induction and fuel injector assembly

(76) Inventor: Kyle Gregoire, Ontario (CA)

Correspondence Address: RANDALL J. KNUTH, P.C., 3510-A Stellhorn Road, Fort Wayne, IN, 46815-4631, US

(21) Appl. No.: 10/140,909

(22) Filed: May 7, 2002

Related U.S. Application Data
(60) Provisional application No. 60/290,831, filed on May 11, 2001.

(51) Int. Cl. H02G 15/013

(52) U.S. Cl. 277/602

(57) ABSTRACT

The present invention relates to a single-piece air induction sealing system. A fuel injector bore is included in the air induction sealing system. The air induction sealing system can be inserted into a manifold runner.

### BACKGROUND OF THE INVENTION

1. Field of the Invention

The present invention relates to a combination of an air induction sealing system with the integration of a fuel injector bore into a single unit that can be inserted into a manifold runner to isolate the manifold from the cylinder head or engine block while reducing the overall assembly profile.

2. Description of the Related Art

Gasoline and diesel engines utilize a compression of a fuel and air mixture to combust within a cylinder to move a piston. Such engines conventionally may use a fuel injector located within the upper manifold, lower manifold or at times within the cylinder head attached to the engine block. The fuel injector located within a fuel injector bore in such systems causes the overall height of the assembly to be larger than necessary.

Additional manufacturing problems may occur in which the fuel injector bore needs to be machined or formed within such lower intake manifold, upper intake manifold, or within the cylinder head. Such additional forming or machine operations increase the cost of the entire engine.

What is needed is a air induction sealing system with integration of a fuel injector bore to thereby reduce the height of the entire engine assembly along with reducing material used in its construction. Possibly, the lower manifold may be entirely eliminated.

### SUMMARY OF THE INVENTION

According to the present invention, a fuel injector bore for a fuel injector in the structure of a carrier gasket that will seal both the air induction manifold and eliminate the need for a separate lower intake manifold is provided.

This structure permits an overall reduction in the height of the engine assembly, as well as, isolation of the manifold from the cylinder head or engine block.

The air induction system member may include separate gaskets on the top and the bottom for allowing accommodation for dissimilar materials as well as greater tolerance acceptance versus traditional carrier gaskets. Either press in place gaskets along the top or bottom sealing surfaces along with a fuel injector bore are molded into the side of the component. Other types of elastomeric seals such as O-rings, lip seals, and face seals or other equivalent seals may be used.

The fuel injector bore is nested into a cutout detail in the manifold runner to allow the entire component to slide up into the runner effectively eliminating the traditional lower intake manifold while isolating the upper manifold from the cylinder head. Upon assembly, the member component is trapped between the manifold and the cylinder head through fasteners such as traditional isolated or non-isolated mounting posts depending upon the mounting strategy of the manifold supplier.

The invention, in one form thereof, comprises a sleeve having a bore through which air may travel. A second bore sized for a fuel injector opens into the first bore. The sleeve is formed for mounting between an upper intake manifold and either a cylinder head or engine block.

The invention, in another form thereof, comprises one or more single-piece assemblies each having an air inlet bore, a fuel injector bore and an air and fuel outlet. The fuel injector bore is in communication with the air inlet bore.

The invention, in yet another form thereof, comprises one or more single-piece assemblies each having an air inlet bore, a fuel injector bore, an air and fuel outlet and one or more sealing grooves. The fuel injector bore is in communication with the air inlet bore.

An advantage of the present invention is that the air induction sealing system may be integrated with the fuel injector bore in a single assembly.

Another advantage of the present invention is the ability to isolate the intake manifold from the cylinder head while reducing the overall assembly height and eliminating the additional machining or forming operations to form the fuel injector bore.

A further advantage of the present invention is that the reduction of the material by possibly eliminating the use or the necessity of the lower intake manifold is apparent.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a sectional view of one form of the present invention;

FIG. 2 is a side view of the air induction sealing system of FIG. 1;

FIG. 3 is a top view of the air induction sealing system of FIG. 1;

FIG. 4 is a bottom view of the air induction sealing system of FIG. 1;

FIG. 5 is a prior art diagram of an existing manifold configuration with the lower manifold having fuel injector bores;

FIG. 6 is a prior art view of an upper and lower manifold combination in which the fuel injector bores are located within the cylinder head;

FIG. 7 is an alternate embodiment of the present invention showing one form of a plurality of air induction sealing systems including fuel injector bores attached to a single plate;

FIG. 8 shows a plurality of air induction sealing systems connected by adjoining tabs;

FIG. 9 shows an embodiment of the present invention in which the air induction sealing system with the fuel injector bore can attach to a manifold runner and cylinder block;

FIG. 10 is another embodiment of the present invention in which the air induction sealing system is shown located between the manifold runner and cylinder block with a use of trapped seals either molded in the top of the assembly or located within the seal grooves retained in the assembly;

FIG. 11 is an alternate embodiment of the present invention in which the seals are located within grooves of the manifold runner itself;

FIG. 12 is an enlarged top view of the air induction sealing system with a seal molded in place;

FIG. 13 is a drawing similar to the enlarged view of FIG. 12 showing a press-in-place seal located within a seal groove; and

FIG. 14 shows an alternate embodiment of the present invention in which the air induction sealing system integrated with the fuel injector bore may be attached into a manifold runner by attachment bosses, clips, fasteners, or other attachment means with an interfitting elastomeric seal.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

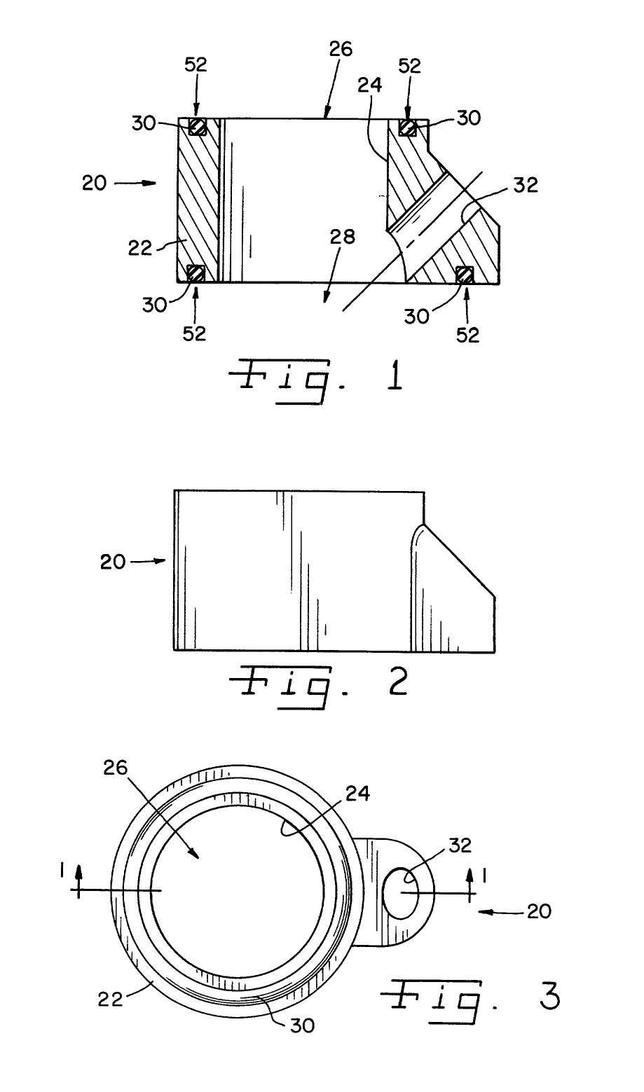

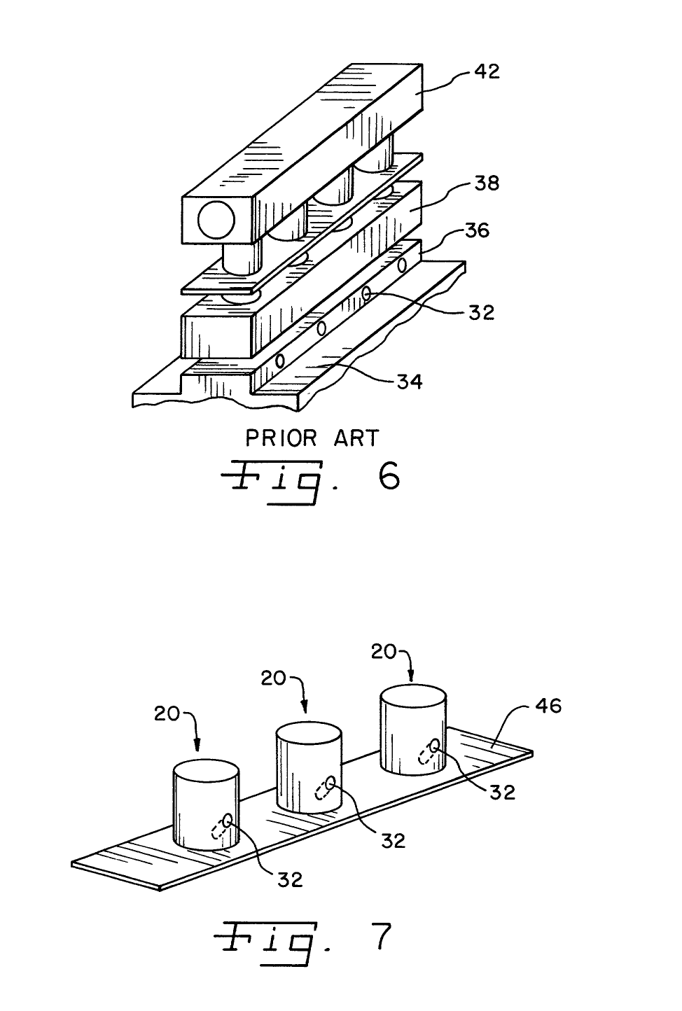

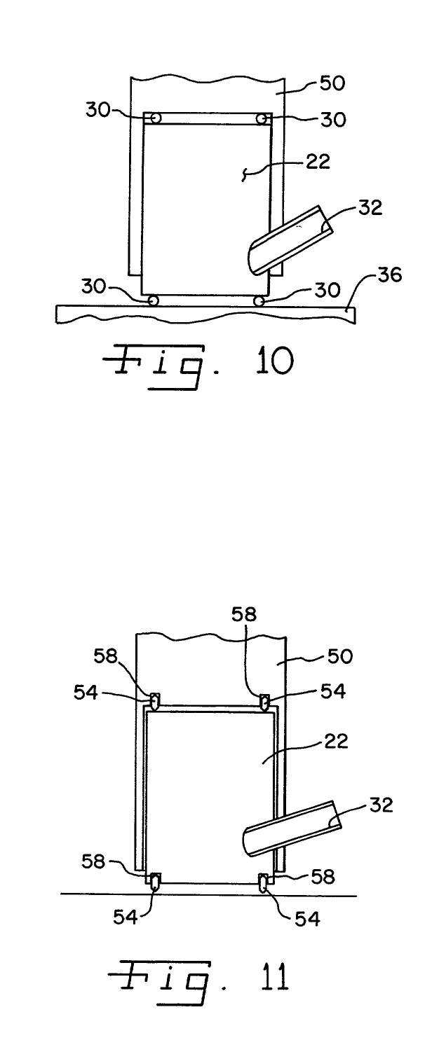

Referring now to the drawings and particularly to FIG. 1, there is shown an air induction sealing system 20. For the purposes of this application, air induction sealing system 20 could be styled as a conduit, pipe, or tube in any respect including sealing elements on the top and bottom, or as a carrier gasket assembly. More particularly, FIG. 1 shows air induction sealing system 20 formed of a conduit 22 having a conduit bore 24 therein. Conduit bore 24 includes an air inlet 26 and an air and fuel outlet 28. Conduit 22 on each inlet and outlet side includes sealing elements 30 about conduit bore 24. Sealing elements 30 are made from an elastomeric material, such as rubber, but other materials can be utilized as well. Sealing elements 30 may be a press-in-place seal element 54 as shown in FIG. 13, or some other type of seal mechanism such as a molded in-place seal or other elastomeric seal such as a O-ring, lip seal, or face seal as utilized to seal conduit 22 between an upper intake manifold 42 (shown in FIGS. 5 and 6) and either a cylinder head 36 (shown in FIGS. 9 and 10) or cylinder block (not shown).

As shown in FIG. 1, sealing elements 30 are inserted into seal grooves 52. Air induction sealing system 20 further includes a fuel injector bore 32 into which a fuel injector 40 is inserted. Fuel injector 40 is shown in FIG. 14. Fuel injector bore 32 is open to the outside of conduit 22 while further opening into conduit bore 24.

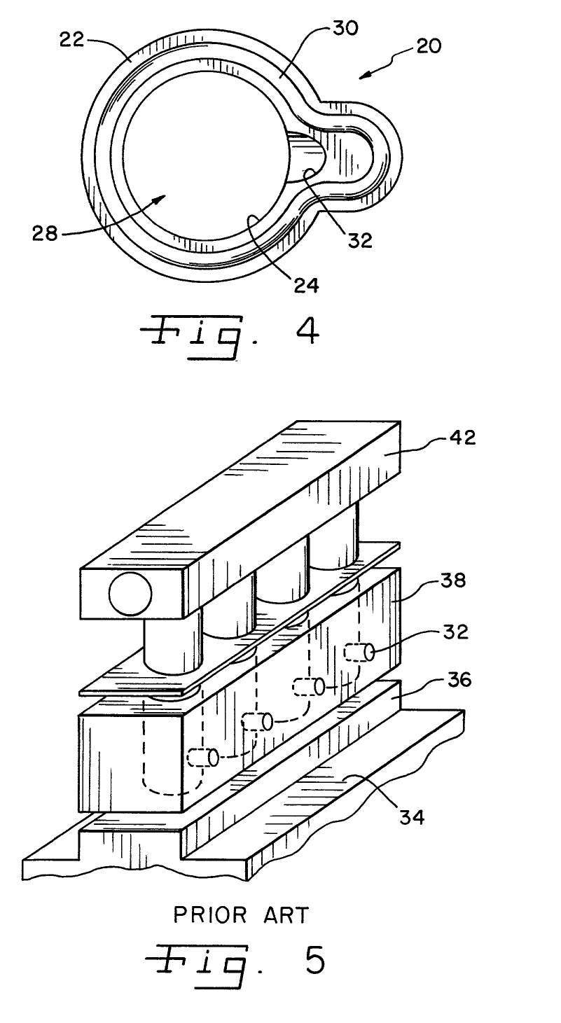

FIG. 2 shows an elevational side profile of air induction sealing system 20. FIG. 3 shows a top view of air induction sealing system 20 of FIG. 1. FIG. 4 shows a bottom view of the same embodiment shown in FIG. 1. Air induction sealing system 20 would be particularly useful for eliminating a lower intake manifold 38 (shown in FIGS. 5 and 6) in gasoline or diesel engines. Further, it may be utilized in any engine that incorporates air and fuel injection isolation.

The main component of air induction sealing system 20, that of conduit 22, may be formed from a thermal set or thermal plastic material having plastic features. Additionally, conduit 22 may be comprised of rubber incorporating a plastic element for the seal in both the upper and lower positions. Other conventional materials may be utilized such as metals, or other engineered plastics. Air induction sealing system 20 with sealing elements 30 and seal groove 52, as well as, press-in-place seal elements 54 and press-in-place seal grooves 58 would simplify the attachment of the upper intake manifold 42 to that of cylinder head 36 or an engine block 34. Air induction sealing system 20 would additionally eliminate labor and other component failure modes associated with lower intake manifold 38.

The environment into which air induction sealing system 20 could be utilized is shown in the prior art FIGS. 5 and 6. FIGS. 5 and 6 show engine block 34 having cylinder head 36 with lower intake manifold 38 located thereupon. In both FIGS. 5 and 6 upper intake manifold 42 is shown in the build up on the portion of engine block 34. Fuel injector bores 32 are shown in lower manifold 38 in FIG. 5 and in cylinder head 36 in FIG. 6.

In another embodiment, as shown in FIG. 7, a plurality of air induction sealing systems 20 with fuel injector bores 32 (shown in a simplified form) are located about a plate 46 for ease of handling and assembly. Although not shown in FIG. 7, each air induction sealing system 20 would include sealing elements 30.

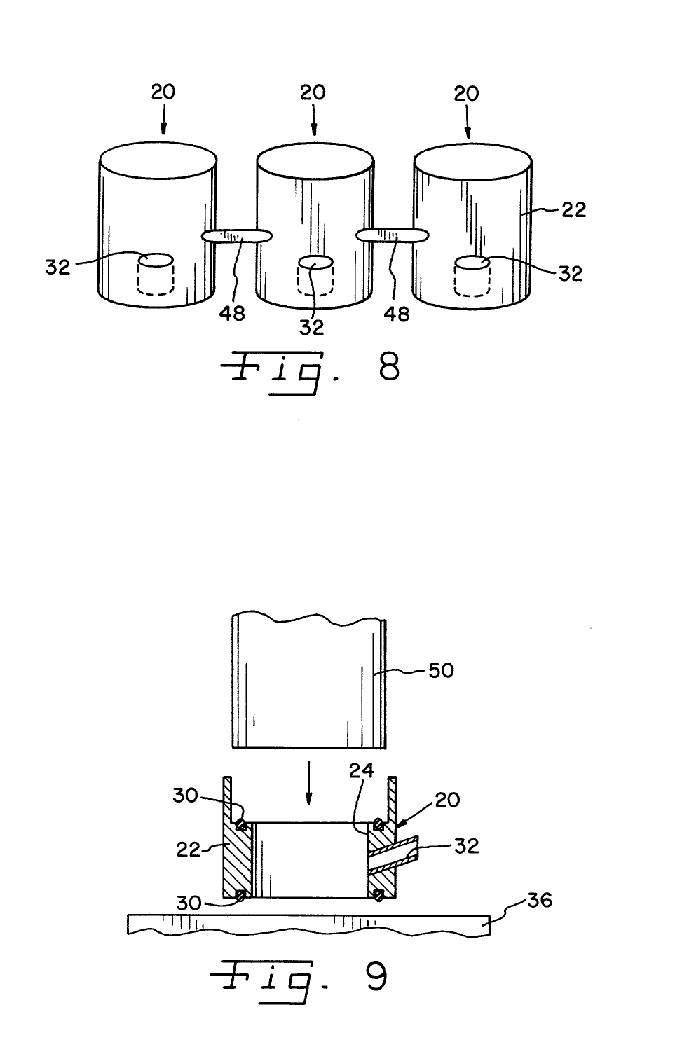

FIG. 8 shows another embodiment of the present invention in which the plurality of air induction sealing systems 20, in simplified form, are connected together by an adjoining tab member 48 or other member to ease assembly and control of the placement of air induction sealing systems 20 within an engine. Tab member 48 may be located at a particular location along conduit 22 such that it would not interfere with the connection of upper intake manifolds 42 to cylinder head 36 or engine block 34.

FIG. 9 shows how a manifold runner 50 of a typical upper intake manifold 42 would interfit into an embodiment of the present invention. As shown in FIG. 9, sealing elements 30 are located for assembly between conduit 22 and both the manifold runner 50 and cylinder head 36. Although in the previous embodiments conduit bore 24 was cylindrical in shape, the present invention does not have such limitation as shown in FIG. 9. Conduit bore 24 may be of various dimensions, shapes and geometries as long as there is communication with fuel injector bore 32 and/or the cylinder block.

FIG. 10 shows an alternate embodiment of the present invention in which manifold runner 50 traps sealing elements 30 between the conduit 22 and itself.

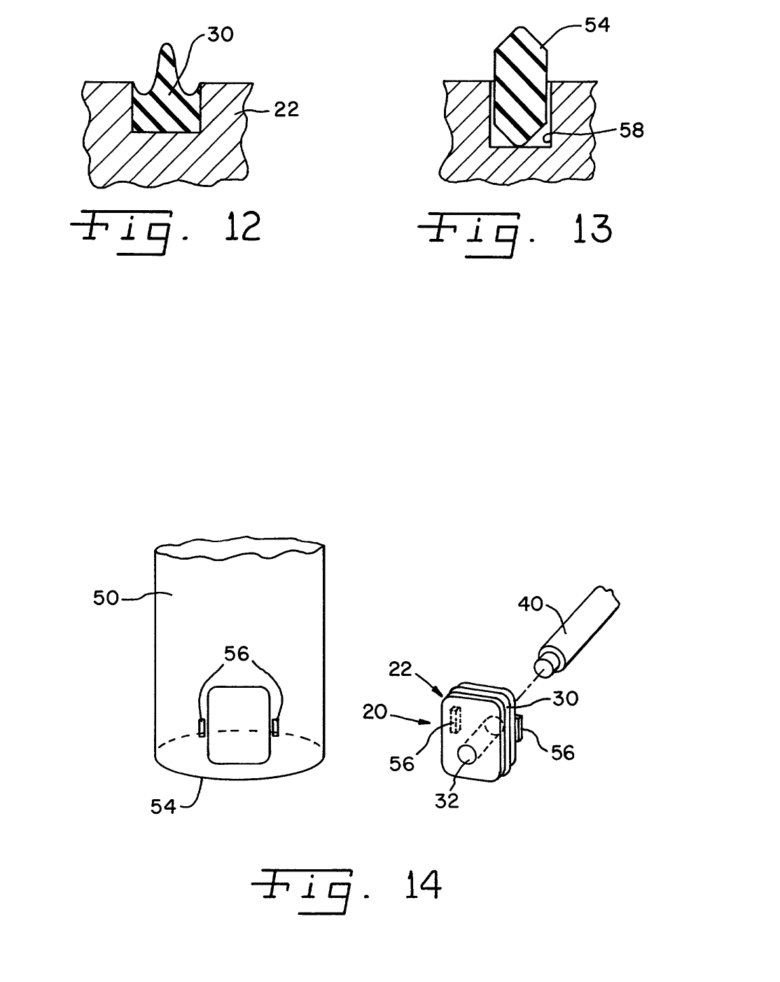

In another embodiment, sealing element 30 may be molded on top of conduit 22 as shown in FIG. 12.

Yet another embodiment, press-in-place seal groove 58 as shown in FIG. 13 may be used to locate a press-in-place seal element 54 of conventional construction. Press-in-place seal element 54 is made from an elastomeric material, such as rubber, but other materials can be utilized as well. Such assembly would be located about conduit bore 24 both on the intake and output side of air induction sealing system 20. FIG. 11 shows this us style of embodiment in which either manifold runner 50 includes a press-in-place seal groove 58 for seating press-in-place seal elements 54 or conduit 22 includes a press-in-place seal groove 58 along either the top, bottom, or both surfaces to include press-in-place seal element 54.

An alternate embodiment of the present invention is shown in FIG. 14 in which air induction sealing system 20 is shown having fuel injector bore 32 formed into conduit 22 which may interfit and connect to manifold runner 50 utilizing an attachment means 56 formed on manifold runner 50 itself. Attachment means 56 can be an attachment boss, clip, fastener or other attaching means. Sealing elements 30 such as an O-ring, lip seal, face seal or other type of seals may be located around the periphery of the modified conduit 22 for sealing of air induction system 20 to manifold runner 50. Alternate attachment means, such as screws, may be utilized as well. In FIG. 14, fuel injector 40 is shown directed to interfit into fuel injector bore 32. The present invention in any of its embodiments would lower the total stack height of the engine allowing more room in the center of the engine for additional parts and/or cooling.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An air induction sealing assembly comprising:
one or more single-piece assemblies each having an air inlet bore, a fuel injector bore and an air and fuel outlet, said fuel injector bore is in communication with said air inlet bore.

2. The assembly in claim 1, further comprising one or more sealing elements.

3. The assembly in claim 2, wherein said one or more sealing elements are at least one of a press-in-place sealing element, an O-ring, a lip seal and a face seal.

4. The assembly in claim 1, further comprising an attachment means for attaching said one or more single-piece assemblies to a manifold runner.

5. The assembly in claim 4, wherein said attachment means is at least one of an attachment boss, clip and fastener.

6. The assembly in claim 4, wherein said manifold runner has one or more seal grooves.

7. The assembly in claim 6, wherein said one or more seal grooves are press-in-place seal grooves.

8. The assembly in claim 1, wherein said one or more single-piece assemblies is at least one of a conduit, pipe, tube and carrier gasket assembly.

9. The assembly in claim 1, wherein said one or more single-piece assemblies are located about a plate.

10. The assembly in claim 1, wherein said one or more single-piece assemblies are connected to one another utilizing a tab member.

11. An air induction sealing assembly comprising:
one or more single-piece assemblies each having an air inlet bore, a fuel injector bore, an air and fuel outlet and one or more sealing grooves, said fuel injector bore is in communication with said air inlet bore.

12. The assembly in claim 11, further comprising one or more sealing elements inserted into said one or more sealing grooves.

13. The assembly in claim 12, wherein said one or more sealing elements are at least one of a press-in-place sealing element, an O-ring, a lip seal and a face seal.

14. The assembly in claim 11, further comprising an attachment means for attaching said one or more single-piece assemblies to a manifold runner.

15. The assembly in claim 14, wherein said attachment means is at least one of an attachment boss, clip and fastener.

16. The assembly in claim 11, wherein said one or more sealing grooves are press-in-place seal grooves.

17. The assembly in claim 11, wherein said single-piece assembly is at least one of a conduit, pipe, tube and carrier gasket assembly.

18. The assembly in claim 11, wherein said one or more single-piece assemblies are located about a plate.

19. The assembly in claim 11, wherein said one or more single-piece assemblies are connected to one another by a tab member.
